(19) United States
(12) Patent Application Publication
(10) Pub. No.: US 2025/0196384 A1
(43) Pub. Date: Jun. 19, 2025

(54) CUTTING APPARATUS FOR CUTTING OFF EXTRUDED PLASTIC PROFILES

(71) Applicant: BATTENFELD-CINCINNATI GERMANY GMBH, Bad Oeynhausen (DE)

(72) Inventors: Heinrich DOHMANN, Bad Oeynhausen (DE); Tobias HUS, Porta Westfalica (DE)

(21) Appl. No.: 18/863,695

(22) PCT Filed: May 10, 2023
(86) PCT No.: PCT/EP2023/062475

§ 371 Date: Nov. 7, 2024

(30) Foreign Application Priority Data
May 20, 2022 (DE) 10 2022 112 814.8

(51) Int. Cl. B26D 3/16; B26D 1/58; B26D 1/62; B26D 5/06; B29C 48/00; B29C 48/12

(52) U.S. Cl. CPC B26D 3/16; B26D 1/58; B26D 5/06; B29C 48/0022; B26D 1/62; B29C 48/12; B29C 2793/009

(57) ABSTRACT

An apparatus for cutting off plastic profiles which are extruded along an extrusion axis, the apparatus including a tool located on a tool carrier, a pivot arm by which the tool carrier together with the tool can be moved towards and away from the extrusion axis, and a device configured to pivot the pivot arm. The tool is connected to the tool carrier and can be aligned, by an adjustment mechanism, with a plane lying at a right angle to the extrusion axis and/or the tool is connected to the tool carrier and the pivot arm, the pivot arm being mounted on the pivoting device, the pivoting device being an electromechanical drive, and the electromechanical drive including at least one cycloidal gear which is directly connected to an actuator.

### CROSS REFERENCE TO RELATED APPLICATIONS

This application is a U.S. National Phase application under 35 U.S.C. § 371 of International Application No. PCT/EP2023/062475, filed on May 10, 2023, and claims benefit to German Patent Application No. DE 10 2022 112 814.8, filed on May 20, 2022. The International Application was published in German on Nov. 23, 2023 as WO 2023/222486 A1 under PCT Article 21(2).

### FIELD

The invention relates to an apparatus for cutting off plastic profiles which are extruded along an extrusion axis, as well as to a related method.

### BACKGROUND

Cutting apparatuses are known from the prior art. For example, DE 10 2020 181 1447 describes an apparatus for cutting an extruded plastic pipe to length by means of a cutting device and a cutting unit that can be rotated about the extrusion axis of the extruded pipe, the cutting unit being rotatably mounted and the cutting being carried out with cutting tools arranged on the cutting unit, wherein energy can be transferred to move the cutting tools, for which purpose elements for transferring energy to moving parts are arranged which are operatively connected to a rotating receiving unit arranged in the cutting unit.

### SUMMARY

In an embodiment, the present disclosure provides an apparatus for cutting off plastic profiles which are extruded along an extrusion axis, the apparatus comprising a tool located on a tool carrier, a pivot arm by which the tool carrier together with the tool can be moved towards and away from the extrusion axis, and a device configured to pivot the pivot arm. The tool is connected to the tool carrier and can be aligned, by an adjustment mechanism, with a plane lying at a right angle to the extrusion axis and/or the tool is connected to the tool carrier and the pivot arm, the pivot arm being mounted on the pivoting device, the pivoting device being an electromechanical drive, and the electromechanical drive comprising at least one cycloidal gear which is directly connected to an actuator.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a typical extrusion line;

FIG. 2 shows a cutting unit of the prior art;

FIG. 3 shows a cutting unit according to an embodiment of the present disclosure;

FIG. 4 illustrates a perspective view of the cutting unit of FIG. 3;

FIGS. 5a-5b, 6a-6b, 7a-7c, 8a-8b, 9a-9b, 10, and 11 illustrate varying views of pivot arms according to embodiments of the present disclosure;

FIGS. 12-15 show varying views of a pivot arm according to an embodiment of the disclosure; and

FIG. 16 illustrates a perspective view of a cutting unit according to an embodiment of the disclosure.

### DETAILED DESCRIPTION

According to an embodiment of the present disclosure, an apparatus for cutting off plastic profiles which are extruded along an extrusion axis comprises a tool located on a tool carrier, a pivot arm by means of which the tool carrier together with the tool can be moved towards and away from the extrusion axis, and a device for pivoting the pivot arm.

It is provided that at least one electrical component is additionally attached to a rotating receiving unit, via which the energy and control commands are passed on to at least one electromechanical unit for moving at least one carrier and cutting tool arranged thereon, wherein the space comprising the electromechanical units, the carrier and the cutting tool arranged thereon is smaller than a hydraulic unit required to generate the same force, wherein the electromechanical units, the carrier or the cutting tool are arranged in such a way that a force counter to the separating force can be avoided if this force is greater than the required cutting force.

The entire system is thus able to take evasive action in the event of an overload in order to avoid damage. This may be necessary if, for example, there is an unrounded shape in the plastic pipe.

However, it cannot specifically reproduce a specific cutting process and therefore cannot move the cutting tool towards or away from the plastic profile at different feed rates.

Further developments to known cutting apparatuses are provided in such a way that they are smaller and comprise fewer components; furthermore, features according to the present disclosure allow a more precise positioning of the cutting tool and to maintain this positioning after a stop.

Advantages of embodiments of the present disclosure are provided in that the tool is connected to the tool carrier and can be aligned, by means of an adjustment mechanism, with a plane lying at a right angle to the extrusion axis and/or the tool is connected to the tool carrier and the pivot arm, the pivot arm being mounted on the pivoting device, the pivoting device being an electromechanical drive, and the electromechanical drive comprising at least one cycloidal gear which is directly connected to an actuator.

The great advantage of using a cycloidal gear with a direct drive via an actuator is its extremely robust internal gear bearing. It is thus provided to use this in an apparatus according to an embodiment of the invention as a pivot bearing for the cutting arm of the cutting apparatus. In this way, the costs and space (installation space) for an additional bearing for the cutting arm can be minimized or saved. The direct drive via the actuator also does away with additional gears and/or deflections. The actuator comprises at least one frequency converter and an electric motor, the electric motor ensuring the pivoting movement of the cutting arm and thus the advance of the cutting apparatus.

According to a further development, it is provided that multiple pivoting devices having a pivot arm mounted thereon with tool carrier and a tool are arranged about the extrusion axis.

A cutting apparatus designed in this way offers a smaller apparatus, which means that more cutting tools (more than two) can be accommodated on one apparatus than is known in the prior art. The use of the electromechanical drive allows precise positioning. In addition, it is achieved that, for example, after the pivot arm has stopped, its position can be maintained, which may not be guaranteed in hydraulic systems due to pressure build-up.

Advantageously, the apparatus also comprises a device for detecting which tool is connected to the tool carrier. Through this detection, the controller can determine whether this tool is suitable for the process to be carried out. If this is not the case, an alarm can be output via the controller or execution can be stopped or refused. This check can be carried out, for example, depending on the pipe diameter or the pipe thickness; the detection can refer to the inserted clamping jaws as well as to the cutting knives or only to cutting tools for chamfering.

According to a further development, the tool is secured in the tool carrier by means of a quick-clamping device. This quick-clamping device can be an eccentric or a bolt connection. In any case, it is ensured that the connection is very precisely tolerated, thus ensuring a good fit. In order to minimize wear on these parts, the parts in question are hardened.

A method according to an embodiment of the invention allows the electromotive feed of the tools not only to position them precisely but also to provide a high degree of flexibility in setting the feed rates. It is therefore provided, for example, that a knife is initially immersed more slowly into the plastic pipe to be cut so that the knife blade stays in place. As soon as the knife is immersed deep enough in the plastic pipe and can no longer move out of place, the speed can be increased again. Just before the knife breaks through the inside of the plastic pipe, the speed can be reduced again in order to avoid breakouts from the material (e.g. due to brittle material).

According to the further development, the feed rate is dependent on the torque. It is therefore intended to couple the feed rate with the torque of the actuator and thus to take into account different requirements when cutting off extruded profiles, preferably pipes here.

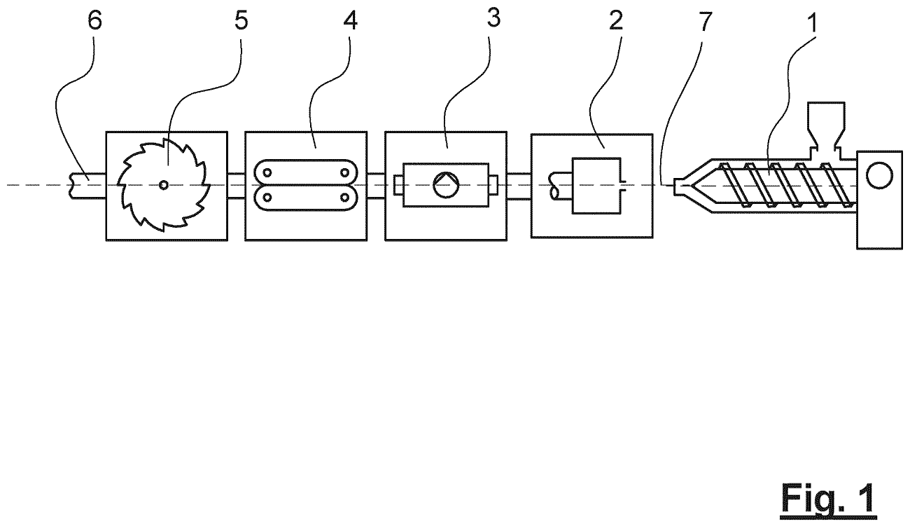

FIG. 1 shows a typical extrusion line as used today for profile extrusion, regardless of whether it is for the production of window profiles or pipes. It shows an extruder 1 in which plastic is melted and continuously fed into the extrusion tool 2 for shaping. This is followed by a calibration and cooling station 3; depending on the profile, additional cooling stations can be used. After the cooling stations there is an extraction device 4. A cutting apparatus 5 is then arranged to cut the endless profiles 6 to the desired length. The extrusion axis is marked with the position number 7.

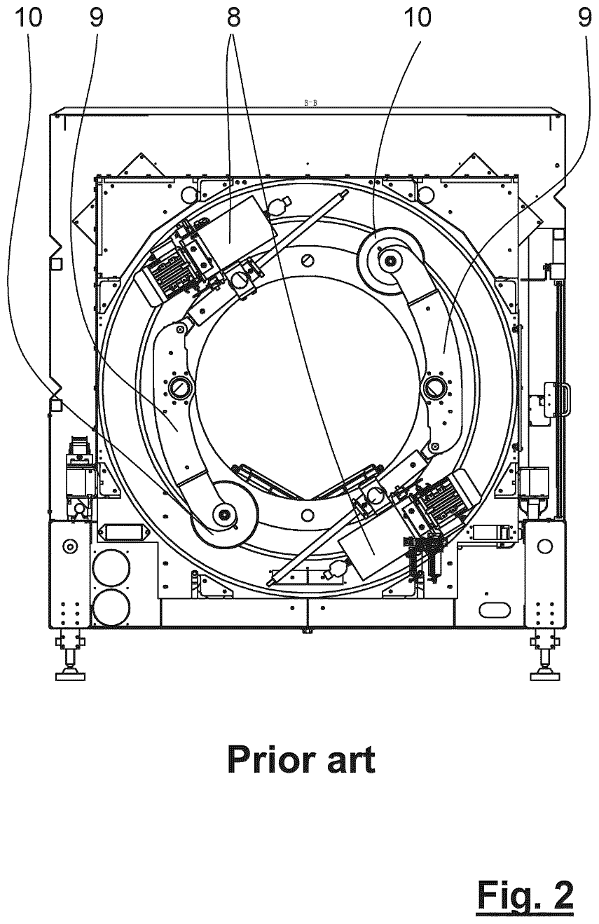

FIG. 2 shows the known prior art in which two hydraulic systems 8 are arranged on a disk 22 rotatable about the extrusion axis, via which two pivot arms 9 having tools 10 arranged thereon can be moved towards or away from the extrusion axis for cutting.

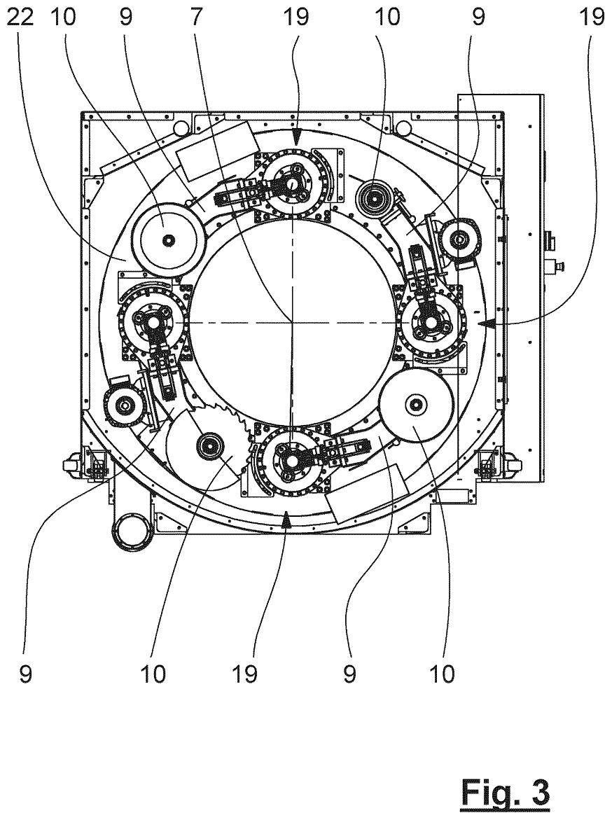

FIG. 3 shows an alternative embodiment of the apparatus. Here too, pivoting devices 19 are arranged on a disk 22 rotatable about the extrusion axis 7. Tools 10 arranged on a pivot arm 9 are pivoted in the direction of the extrusion axis 7 via these drives. In this case, however, the pivoting devices 19 are electromechanical drives. The pivot arm and drive are much smaller, so that, as in this example, these units are arranged four times on the rotating disk 22. As can be seen from the illustration, the tools 10 used can be different. In one case, it is a saw blade with teeth, in another, similar to a pizza cutter, it is a round cutting knife or a tool with which, for example, a bevel can be created.

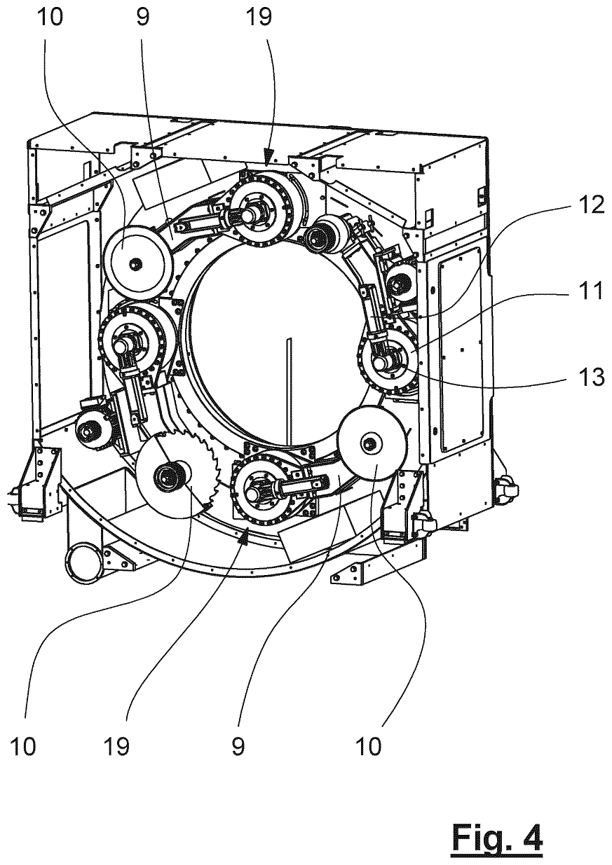

FIG. 4 is a perspective view of FIG. 3, with the same positions again being referred to with the same position numbers. Due to the perspective, other parts of the pivoting device 19 can be made clearer, so that the cycloidal gear 11, the servo motor 12 and the angular gear 13 can be seen.

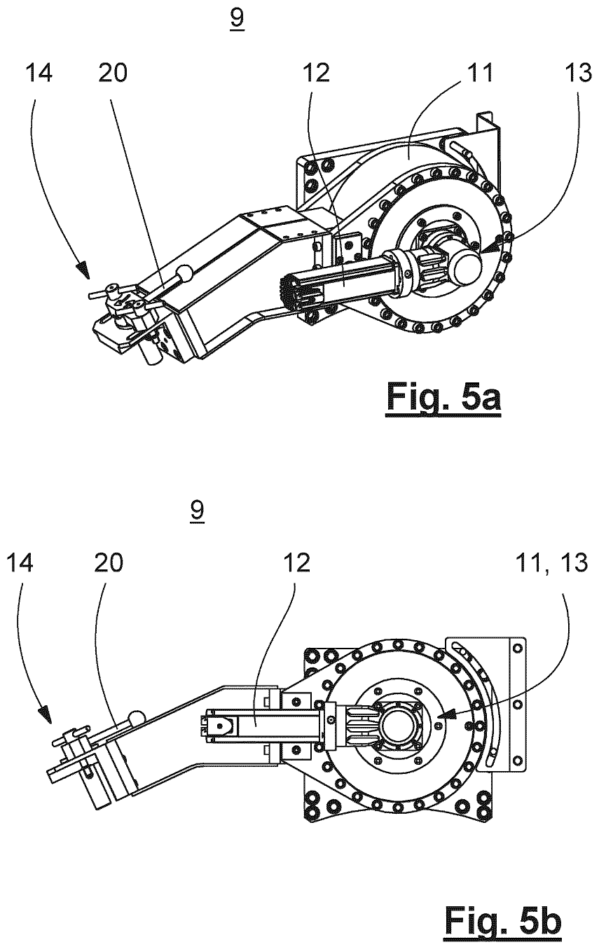

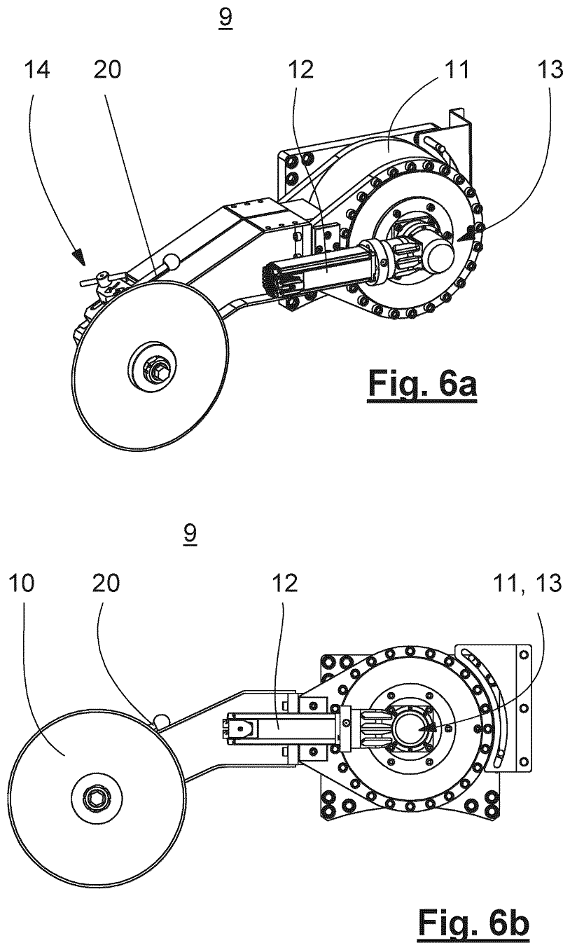

FIG. 5 shows the pivot arm 9 with the cycloidal gear 11, the servo motor 12 and the angular gear 13, as well as the tool carrier 14 with a quick-clamping device 20. A tool 10 arranged on the pivot arm 9 is shown in FIGS. 6a and b.

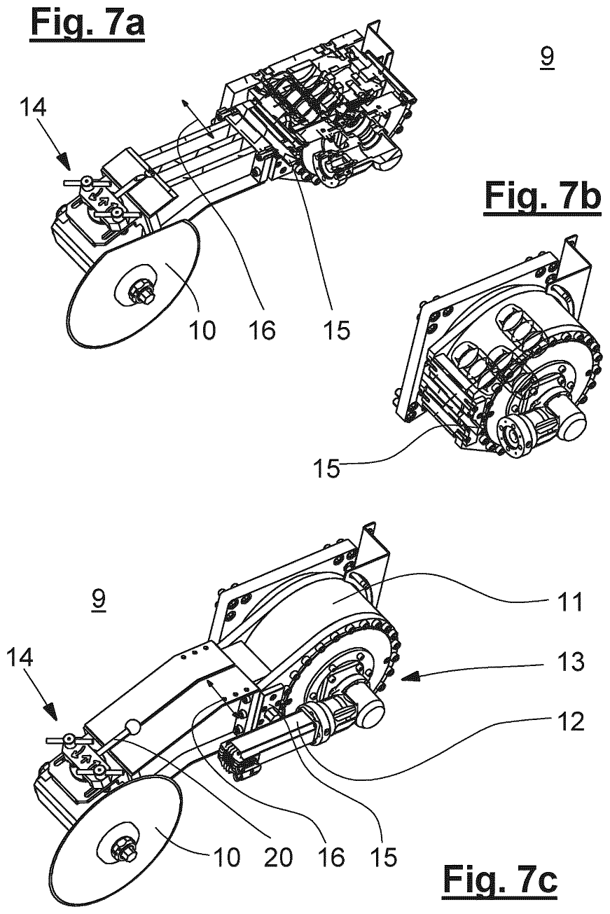

In the illustrations according to FIGS. 7a, 7b and 7c, the pivot arm 9 with the tool carrier 14 and the tool 10 is shown, partly in a sectional view. This makes it possible to adjust the tool carrier 14 in the direction of the extrusion axis using the adjustment device 16 shown by the arrow in FIG. 7a. The adjustment can be implemented by means of the adjustment mechanism 15, here a threaded spindle with hexagon. The mechanism is used to align multiple tools with one another. This may be necessary, for example, if there are tolerance deviations in the components. In this way, all components can be aligned with a plane that is perpendicular to the extrusion axis and thus represents the cutting plane, thus ensuring a clean cutting process of all arranged cutting tools. FIG. 7b shows the suspension on slide rails and the spindle for adjustment in detail and FIG. 7c shows the complete pivot arm 9.

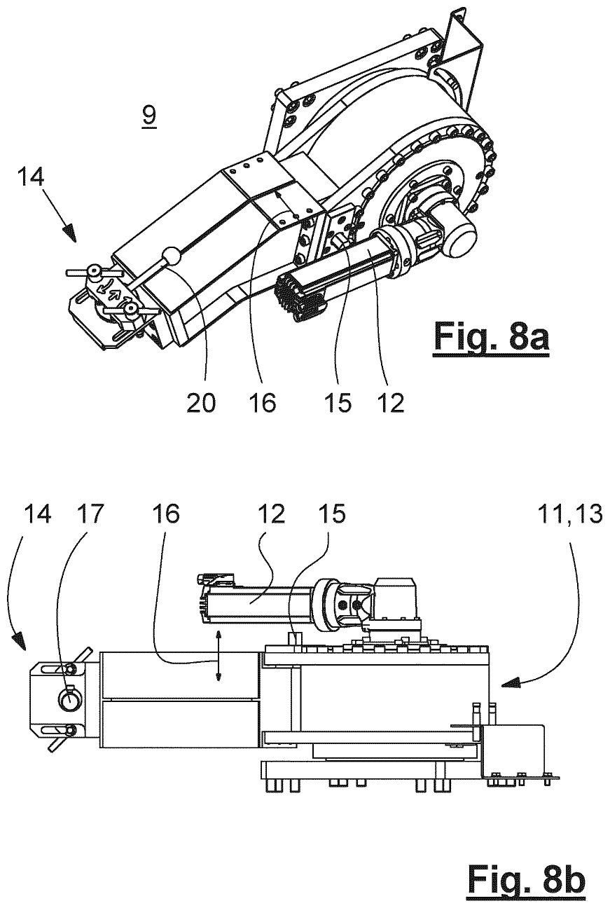

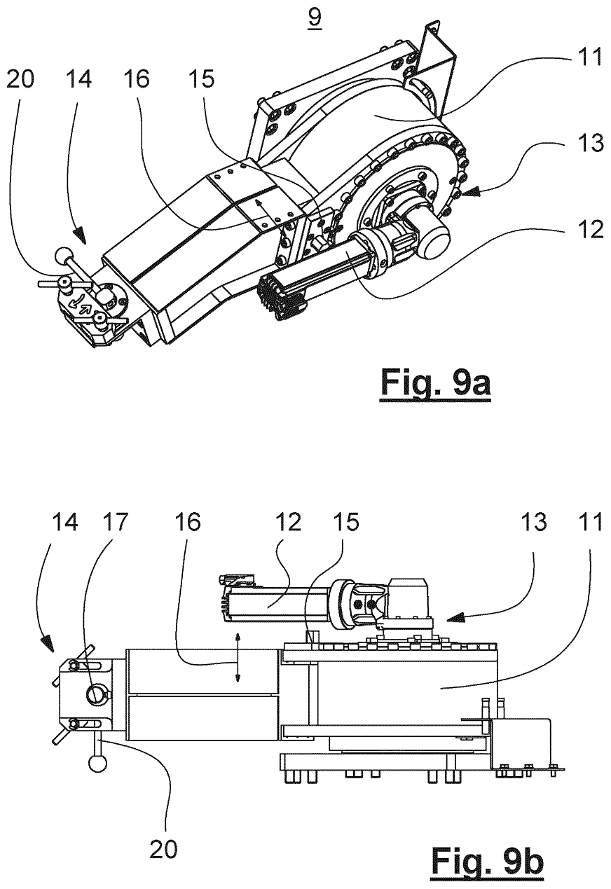

In FIGS. 8a and 8b, the capability to connect the tool 10 and the tool carrier 14 is highlighted. An eccentric 17 is actuated via a quick-clamping device 20, which brings the tool 10, once fixed via the adjusting screws, back into exactly the same position even after it has been loosened. The two different positions of the quick-clamping device 20 are shown in FIGS. 8a and 8b and FIGS. 9a and 9b, respectively.

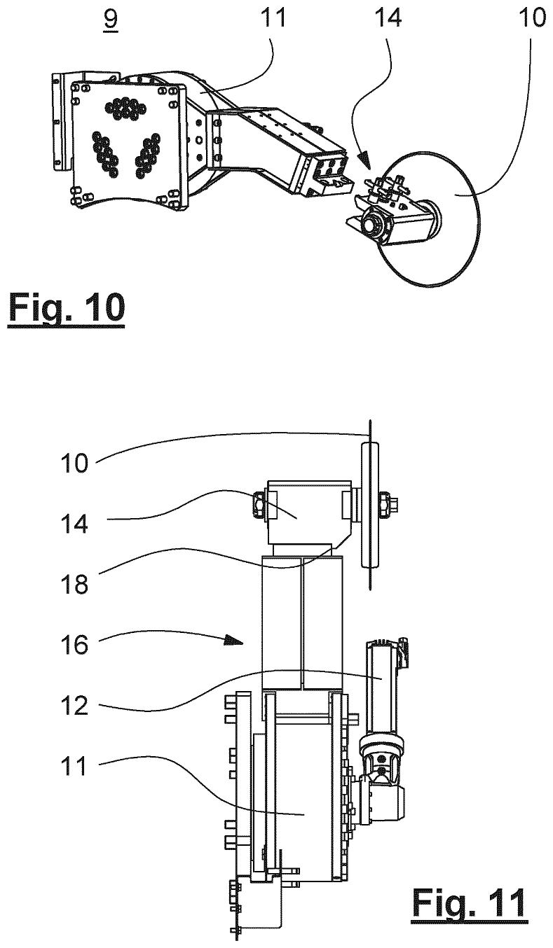

FIG. 10 shows an alternative connection of the tool carrier 14 with the pivot arm 9. Here, the quick-clamping device was dispensed with and exact positioning was ensured by specifying precise manufacturing tolerances.

The view according to FIG. 11 once again shows in detail that the tool carrier 14 has a stop edge 18, which additionally ensures exact positioning of the tool carrier 14.

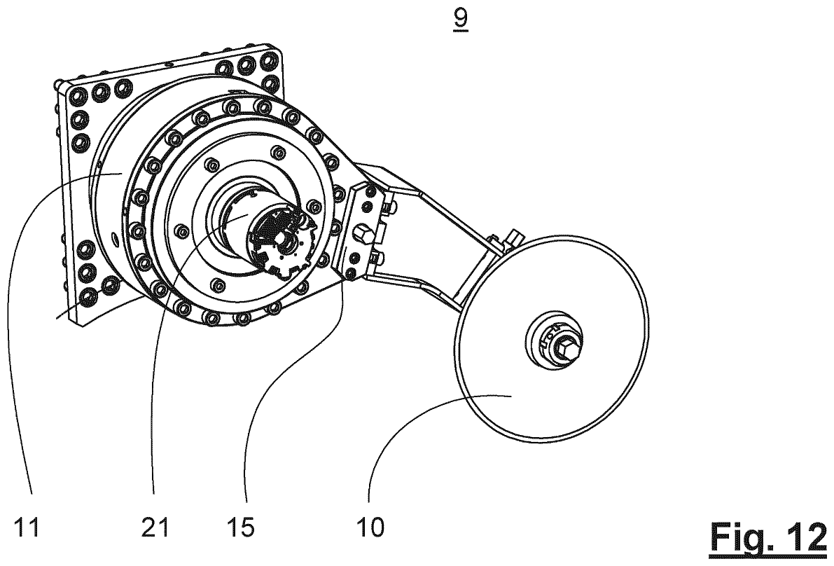

FIG. 12 shows the pivot arm 9 in an embodiment according to the invention. The cutting tool is arranged on a carrier which is connected to the cycloidal gear 11 via the adjustment mechanism 15. In contrast to FIGS. 5a to 11, the cycloidal gear 11 is directly connected to an actuator 21. Therefore, neither the servo motor 12 nor the angular gear 13 are used. The actuator 21 comprises at least one electric motor and a frequency converter.

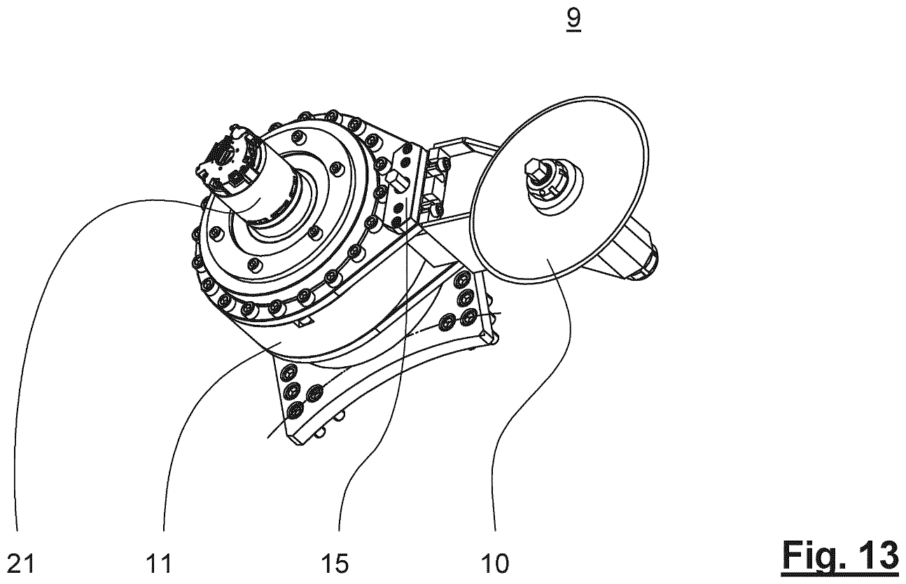

FIG. 13 corresponds to FIG. 12 in a different view, with identical parts being given the same reference signs.

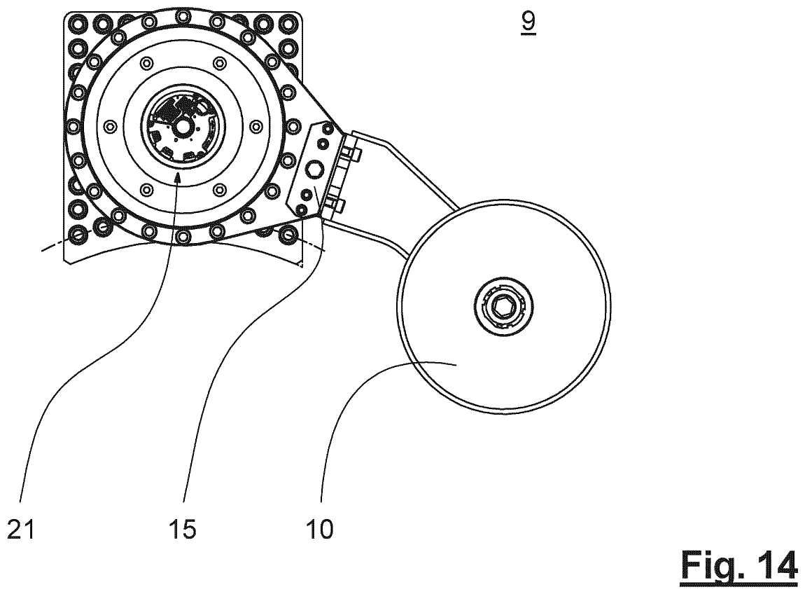

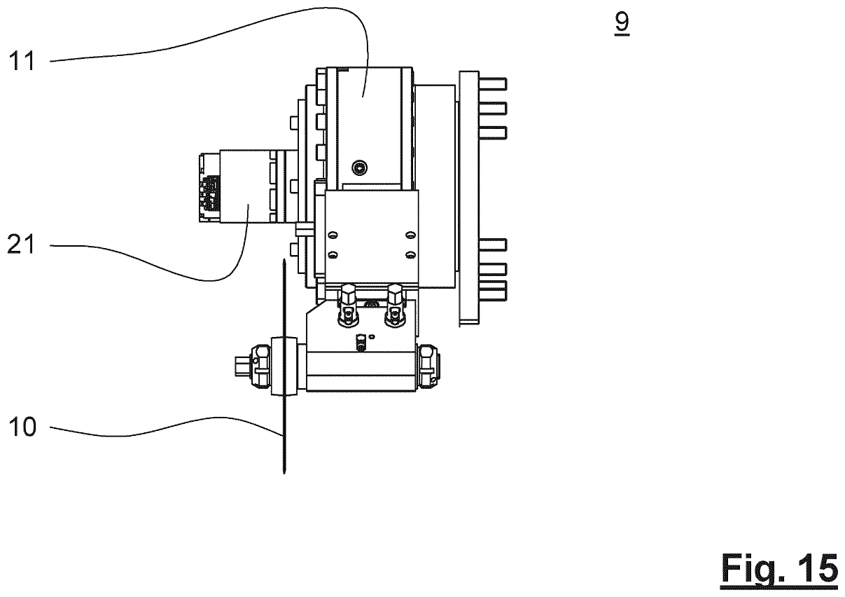

FIG. 14 also corresponds to FIG. 12, but here a 2D view was chosen. Here, too, identical parts are given the same reference signs. This also applies to FIG. 15 which shows another 2D view.

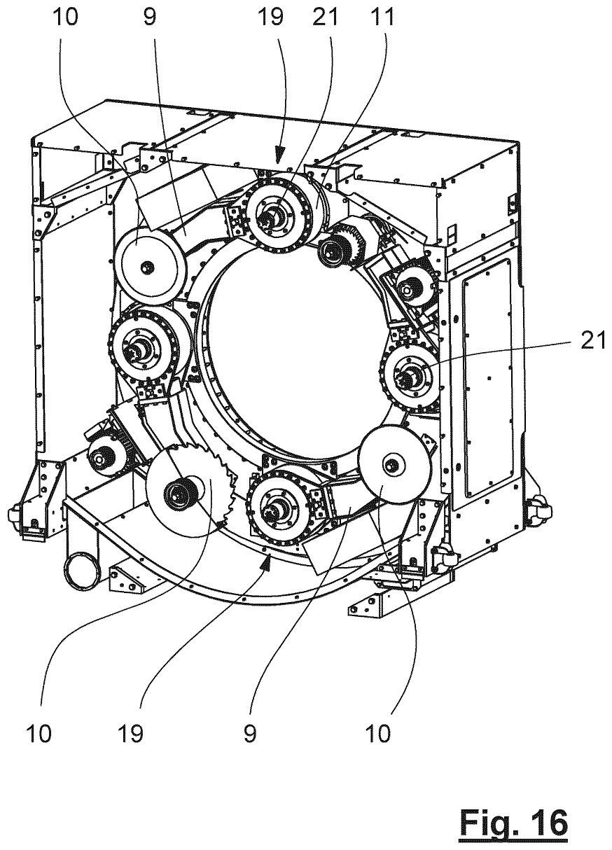

FIG. 16 substantially corresponds to FIG. 4, although, in contrast to FIG. 4, no servo motor 12 and no angular gear 13 are shown here, but rather the pivot arms 19 with the actuator 21.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Extruder
2 Extrusion tool
3 Calibration and cooling tank
4 Extraction device
5 Cutting apparatus
6 Profile
7 Extrusion axis
8 Hydraulic system
9 Pivot arm
10 Tool
11 Cycloidal gear
12 Servo motor
13 Angular gear
14 Tool carrier
15 Adjustment mechanism for 14
16 Adjustment device
17 Eccentric
18 Stop edge at 14
19 Pivoting device
20 Quick-clamping device
21 Actuator
22 Rotatable disk

### DESCRIPTION

The invention relates to an apparatus for cutting off plastic profiles which are extruded along an extrusion axis, the apparatus at least comprising: a tool located on a tool carrier; a pivot arm by means of which the tool carrier together with the tool can be moved towards and away from the extrusion axis; and a device for pivoting the pivot arm, as well as to a related method.

Cutting apparatuses are known from the prior art. For example, DE 10 2020 181 1447 describes an apparatus for cutting an extruded plastic pipe to length by means of a cutting device and a cutting unit that can be rotated about the extrusion axis of the extruded pipe, the cutting unit being rotatably mounted and the cutting being carried out with cutting tools arranged on the cutting unit, wherein energy can be transferred to move the cutting tools, for which purpose elements for transferring energy to moving parts are arranged which are operatively connected to a rotating receiving unit arranged in the cutting unit.

According to the invention, it is provided that at least one electrical component is additionally attached to the rotating receiving unit, via which the energy and control commands are passed on to at least one electromechanical unit for moving at least one carrier and cutting tool arranged thereon, wherein the space comprising the electromechanical units, the carrier and the cutting tool arranged thereon is smaller than a hydraulic unit required to generate the same force, wherein the electromechanical units, the carrier or the cutting tool are arranged in such a way that a force counter to the separating force can be avoided if this force is greater than the required cutting force.

The entire system is thus able to take evasive action in the event of an overload in order to avoid damage. This may be necessary if, for example, there is an unrounded shape in the plastic pipe.

However, it cannot specifically reproduce a specific cutting process and therefore cannot move the cutting tool towards or away from the plastic profile at different feed rates.

The object of the invention is to further develop known cutting apparatuses in such a way that they are smaller and comprise fewer components; furthermore, the object is to allow a more precise positioning of the cutting tool and to maintain this positioning after a stop.

The object is achieved, in conjunction with the preamble of claim 1, in that the tool is connected to the tool carrier and can be aligned, by means of an adjustment mechanism, with a plane lying at a right angle to the extrusion axis and/or the tool is connected to the tool carrier and the pivot arm, the pivot arm being mounted on the pivoting device, the pivoting device being an electromechanical drive, and the electromechanical drive comprising at least one cycloidal gear which is directly connected to an actuator.

The great advantage of using a cycloidal gear with a direct drive via an actuator is its extremely robust internal gear bearing. It is thus possible to use this in the apparatus according to the invention as a pivot bearing for the cutting arm of the cutting apparatus. In this way, the costs and space (installation space) for an additional bearing for the cutting arm can be minimized or saved. The direct drive via the actuator also does away with additional gears and/or deflections. The actuator comprises at least one frequency converter and an electric motor, the electric motor ensuring the pivoting movement of the cutting arm and thus the advance of the cutting apparatus.

According to a further development, it is provided that multiple pivoting devices having a pivot arm mounted thereon with tool carrier and a tool are arranged about the extrusion axis.

A cutting apparatus designed in this way offers a smaller apparatus, which means that more cutting tools (more than two) can be accommodated on one apparatus than is known in the prior art. The use of the electromechanical drive allows precise positioning. In addition, it is achieved that, for example, after the pivot arm has stopped, its position can be maintained, which may not be guaranteed in hydraulic systems due to pressure build-up.

Advantageously, the apparatus also comprises a device for detecting which tool is connected to the tool carrier. Through this detection, the controller can determine whether this tool is suitable for the process to be carried out. If this is not the case, an alarm can be output via the controller or execution can be stopped or refused. This check can be carried out, for example, depending on the pipe diameter or the pipe thickness; the detection can refer to the inserted clamping jaws as well as to the cutting knives or only to cutting tools for chamfering.

According to a further development, the tool is secured in the tool carrier by means of a quick-clamping device. This quick-clamping device can be an eccentric or a bolt connection. In any case, it is ensured that the connection is very precisely tolerated, thus ensuring a good fit. In order to minimize wear on these parts, the parts in question are hardened.

The solution regarding the method is presented in claim 7. Advantageous developments are specified in the dependent claims.

The method according to the invention allows the electromotive feed of the tools not only to position them precisely but also to provide a high degree of flexibility in setting the feed rates. It is therefore conceivable, for example, that a knife is initially immersed more slowly into the plastic pipe to be cut so that the knife blade stays in place. As soon as the knife is immersed deep enough in the plastic pipe and can no longer move out of place, the speed can be increased again. Just before the knife breaks through the inside of the plastic pipe, the speed can be reduced again in order to avoid breakouts from the material (e.g. due to brittle material).

According to the further development, the feed rate is dependent on the torque. It is therefore intended to couple the feed rate with the torque of the actuator and thus to take into account different requirements when cutting off extruded profiles, preferably pipes here.

The drawings schematically show an apparatus according to the invention:

FIG. 1 shows a typical extrusion line

FIG. 2 shows a cutting unit of the prior art

FIG. 3 shows an alternative embodiment of the cutting unit according to the invention

FIG. 4 is a perspective view according to FIG. 3

FIG. 5 to 11 show different views of the pivot arm with a different design

FIG. 12 to 15 show different views of the pivot arm according to the invention

FIG. 16 is a perspective view of the cutting unit according to the invention

FIG. 1 shows a typical extrusion line as used today for profile extrusion, regardless of whether it is for the production of window profiles or pipes. It shows an extruder 1 in which plastic is melted and continuously fed into the extrusion tool 2 for shaping. This is followed by a calibration and cooling station 3; depending on the profile, additional cooling stations can be used. After the cooling stations there is an extraction device 4. A cutting apparatus 5 is then arranged to cut the endless profiles 6 to the desired length. The extrusion axis is marked with the position number 7.

FIG. 2 shows the known prior art in which two hydraulic systems 8 are arranged on a disk 22 rotatable about the extrusion axis, via which two pivot arms 9 having tools 10 arranged thereon can be moved towards or away from the extrusion axis for cutting.

FIG. 3 shows an alternative embodiment of the apparatus. Here too, pivoting devices 19 are arranged on a disk 22 rotatable about the extrusion axis 7. Tools 10 arranged on a pivot arm 9 are pivoted in the direction of the extrusion axis 7 via these drives. In this case, however, the pivoting devices 19 are electromechanical drives. The pivot arm and drive are much smaller, so that, as in this example, these units are arranged four times on the rotating disk 22. As can be seen from the illustration, the tools 10 used can be different. In one case, it is a saw blade with teeth, in another, similar to a pizza cutter, it is a round cutting knife or a tool with which, for example, a bevel can be created.

FIG. 4 is a perspective view of FIG. 3, with the same positions again being referred to with the same position numbers. Due to the perspective, other parts of the pivoting device 19 can be made clearer, so that the cycloidal gear 11, the servo motor 12 and the angular gear 13 can be seen.

FIG. 5 shows the pivot arm 9 with the cycloidal gear 11, the servo motor 12 and the angular gear 13, as well as the tool carrier 14 with a quick-clamping device 20. A tool 10 arranged on the pivot arm 9 is shown in FIGS. 6a and b.

In the illustrations according to FIGS. 7a, 7b and 7c, the pivot arm 9 with the tool carrier 14 and the tool 10 is shown, partly in a sectional view. This makes it possible to adjust the tool carrier 14 in the direction of the extrusion axis using the adjustment device 16 shown by the arrow in FIG. 7a. The adjustment can be implemented by means of the adjustment mechanism 15, here a threaded spindle with hexagon. The mechanism is used to align multiple tools with one another. This may be necessary, for example, if there are tolerance deviations in the components. In this way, all components can be aligned with a plane that is perpendicular to the extrusion axis and thus represents the cutting plane, thus ensuring a clean cutting process of all arranged cutting tools. FIG. 7b shows the suspension on slide rails and the spindle for adjustment in detail and FIG. 7c shows the complete pivot arm 9.

In FIGS. 8a and 8b, the possibility of connecting the tool 10 and the tool carrier 14 is highlighted. An eccentric 17 is actuated via a quick-clamping device 20, which brings the tool 10, once fixed via the adjusting screws, back into exactly the same position even after it has been loosened. The two different positions of the quick-clamping device 20 are shown in FIGS. 8a and 8b and FIGS. 9a and 9b, respectively.

FIG. 10 shows an alternative connection of the tool carrier 14 with the pivot arm 9. Here, the quick-clamping device was dispensed with and exact positioning was ensured by specifying precise manufacturing tolerances.

The view according to FIG. 11 once again shows in detail that the tool carrier 14 has a stop edge 18, which additionally ensures exact positioning of the tool carrier 14.

FIG. 12 shows the pivot arm 9 in the embodiment according to the invention. The cutting tool is arranged on a carrier which is connected to the cycloidal gear 11 via the adjustment mechanism 15. In contrast to FIGS. 5a to 11, the cycloidal gear 11 is directly connected to an actuator 21. Therefore, neither the servo motor 12 nor the angular gear 13 are used. The actuator 21 comprises at least one electric motor and a frequency converter.

FIG. 13 corresponds to FIG. 12 in a different view, with identical parts being given the same reference signs.

FIG. 14 also corresponds to FIG. 12, but here a 2D view was chosen. Here, too, identical parts are given the same reference signs. This also applies to FIG. 15 which shows another 2D view.

FIG. 16 substantially corresponds to FIG. 4, although, in contrast to FIG. 4, no servo motor 12 and no angular gear 13 are shown here, but rather the pivot arms 19 with the actuator 21.

### LIST OF REFERENCE SIGNS

1 Extruder
2 Extrusion tool
3 Calibration and cooling tank
4 Extraction device
5 Cutting apparatus
6 Profile
7 Extrusion axis
8 Hydraulic system
9 Pivot arm
10 Tool
11 Cycloidal gear
12 Servo motor
13 Angular gear
14 Tool carrier
15 Adjustment mechanism for 14
16 Adjustment device
17 Eccentric
18 Stop edge at 14
19 Pivoting device
20 Quick-clamping device
21 Actuator
22 Rotatable disk

1: An apparatus for cutting off plastic profiles which are extruded along an extrusion axis, the apparatus comprising:
a tool located on a tool carrier;
a pivot arm by which the tool carrier together with the tool can be moved towards and away from the extrusion axis; and
a device configured to pivot the pivot arm,
wherein the tool is connected to the tool carrier and can be aligned, by an adjustment mechanism, with a plane lying at a right angle to the extrusion axis and/or wherein the tool is connected to the tool carrier and the pivot arm, the pivot arm being mounted on the pivoting device, the pivoting device being an electromechanical drive, and the electromechanical drive comprising at least one cycloidal gear which is directly connected to an actuator.

2: The apparatus according to claim 1, wherein multiple pivoting devices having a pivot arm mounted thereon with a tool carrier and a tool are arranged about the extrusion axis.

3: The apparatus according to claim 2, comprising an apparatus for detecting the tool is.

4: The apparatus according to claim 1, wherein the tool is secured in the tool carrier by a quick-clamping device.

5: The apparatus according to claim 4, wherein the quick-clamping device is eccentric.

6: The apparatus according to claim 4, wherein the quick-clamping device is a bolt connection.

7: A method for cutting off plastic profiles which are extruded along an extrusion axis,
providing the apparatus according to claim 1;
controlling a pivoting of the pivoting device with a controller, thereby influencing a feed rate with which the tool is fed radially onto the profile to be cut off and is guided through it, the feed rate of the pivoting being represented by a graph.

8: The method according to claim 7, wherein the feed rate is a straight line equation or a gradation of multiple straight line equations.

9: The method according to claim 7, wherein the feed rate initially increases until the tool has reached an outer region of the profile, then flattens out until the tool has reached a predetermined penetration depth and then increases again until the cutting process is completed.

10: The method according to claim 7, wherein the feed rate is dependent on a torque.
